(19) United States
(12) Patent Application Publication
(10) Pub. No.: US 2014/0185179 A1
(43) Pub. Date: Jul. 3, 2014

(54) SELF-CONTAINED STATIC ELECTRICITY DRAIN

(71) Applicant: Charles Eugene Simon, Burnsville, MN (US)

(72) Inventor: Charles Eugene Simon, Burnsville, MN (US)

(21) Appl. No.: 13/733,281

(22) Filed: Jan. 3, 2013

(51) Int. Cl. H05F 3/02; H01R 43/00

(52) U.S. Cl. CPC H05F 3/02; H01R 43/00
USPC 361/220; 29/825

(57) ABSTRACT

A static electricity removal system for removing aerial borne static has:
a conductive shell,
a removal system support system, and
a conductive internal element supported by the removal system support,
   wherein the conductive internal element being free of conductive contact with the shell, one end of the conductive internal element being directed towards an exit port from the shell, the one end of the conductive internal element in electrical connection with an insulated electrical drain element, and the insulated electrical element being grounded.

### BACKGROUND OF THE INVENTION

1. Field of the Invention

The present invention relates to the field o static electricity, especially air-borne static electricity and the removal or environmental static electricity.

2. Background of the Art

Static electricity is an excess of electric charge trapped on the surface of an object. The charge remains until it is allowed to escape to an object with a weaker or opposite electrical charge, such as the ground, by means of an electrical current or electrical discharge. Static electricity is named in contrast with current electricity, which flows through wires or other conductors and transmits energy.

A static electric charge is created whenever two surfaces come into contact and separate, and at least one of the surfaces has a high resistance to electrical current (and is therefore an electrical insulator). The effects of static electricity are familiar to most people because people can feel, hear, and even see the spark as the excess charge is neutralized when brought close to a large electrical conductor (for example, a path to ground), or a region with an excess charge of the opposite polarity (positive or negative). The familiar phenomenon of a static shock—more specifically, an electrostatic discharge—is caused by the neutralization of charge.

Removing or preventing a buildup of static charge can be as simple as opening a window or using a humidifier to increase the moisture content of the air, making the atmosphere more conductive. Air ionizers can perform the same task.

Items that are particularly sensitive to static discharge may be treated with the application of antistatic agent, which adds a conducting surface layer that ensures any excess charge is evenly distributed. Fabric softeners and dryer sheets used in washing machines and clothes dryers are an example of an antistatic agent used to prevent and remove static cling.

Many semiconductor devices used in electronics are particularly sensitive to static discharge. In the industrial settings such as paint or flour plants as well as in hospitals, antistatic safety boots are sometimes used to prevent a buildup of static charge due to contact with the floor. These shoes have soles with good conductivity. Anti-static shoes should not be confused with insulating shoes, which provide exactly the opposite benefit—some protection against serious electric shock from the main voltage.

The spark associated with static electricity is caused by electrostatic discharge, or simply static discharge, as excess charge is neutralized by a flow of charges from or to the surroundings.

The feeling of an electric shock is caused by the stimulation of nerves as the neutralizing current flows through the human body. The energy stored as static electricity on an object varies depending on the size of the object and its capacitance, the voltage to which it is charged, and the dielectric constant of the surrounding medium. For modeling the effect of static discharge on sensitive electronic devices, a human being is represented as a capacitor of 100 picofarads, charged to a voltage of 4000 to 35000 volts. When touching an object this energy is discharged in less than a microsecond. While the total energy is small, on the order of millijoules, it can still damage sensitive electronic devices. Larger objects will store more energy, which may be directly hazardous to human contact or which may give a spark that can ignite flammable gas or dust.

Lightning is a dramatic natural example of static discharge. While the details are unclear and remain a subject of debate, the initial charge separation is thought to be associated with contact between ice particles within storm clouds. In general, significant charge accumulations can only persist in regions of low electrical conductivity (very few charges free to move in the surroundings), hence the flow of neutralizing charges often results from neutral atoms and molecules in the air being torn apart to form separate positive and negative charges, which travel in opposite directions as an electric current, neutralizing the original accumulation of charge. The static charge in air typically breaks down in this way at around 10,000 volts per centimeter (10 kV/cm) depending on humidity. The discharge superheats the surrounding air causing the bright flash, and produces a shock wave causing the clicking sound. The lightning bolt is simply a scaled up version of the sparks seen in more domestic occurrences of static discharge. The flash occurs because the air in the discharge channel is heated to such a high temperature that it emits light by incandescence. The clap of thunder is the result of the shock wave created as the superheated air expands explosively.

### Electronic Components

Many semiconductor devices used in electronics are very sensitive to the presence of static electricity and can be damaged by a static discharge. The use of an antistatic strap is mandatory for researchers manipulating nanodevices. Further precautions can be taken by taking off shoes with thick rubber soles and permanently staying with a metallic ground.

### Static Build-Up In Flowing Flammable And Ignitable Materials

Discharge of static electricity can create severe hazards in those industries dealing with flammable substances, where a small electrical spark may ignite explosive mixtures.

The flowing movement of finely powdered substances or low conductivity fluids in pipes or through mechanical agitation can build up static electricity. Dust clouds of finely powdered substances can become combustible or explosive. When there is a static discharge in a dust or vapor cloud, explosions have occurred.

The ability of a fluid to retain an electrostatic charge depends on its electrical conductivity. When low conductivity fluids flow through pipelines or are mechanically agitated, contact-induced charge separation called flow electrification occurs. Fluids that have low electrical conductivity (below 50 picosiemens per meter), are called accumulators. Fluids having conductivities above 50 pS/m are called non-accumulators. In non-accumulators, charges recombine as fast as they are separated and hence electrostatic charge accumulation is not significant. In the petrochemical industry, 50 pS/m is the recommended minimum value of electrical conductivity for adequate removal of charge from a fluid.

Kerosines may have conductivity ranging from less than 1 picosiemens per meter to 20 pS/m. For comparison, deionized water has a conductivity of about 10,000,000 pS/m or 10 μS/m.

Transformer oil is part of the electrical insulation system of large power transformers and other electrical apparatus. Re-filling of large apparatus requires precautions against electrostatic charging of the fluid, which may damage sensitive transformer insulation.

An important concept for insulating fluids is the static relaxation time. This is similar to the time constant τ (tau) within an RC circuit. For insulating materials, it is the ratio of the static dielectric constant divided by the electrical conductivity of the material. For hydrocarbon fluids, this is sometimes approximated by dividing the number 18 by the electrical conductivity of the fluid. Thus a fluid that has an electrical conductivity of 1 pS/m has an estimated relaxation time of about 18 seconds. The excess charge in a fluid dissipates almost completely after four to five times the relaxation time, or 90 seconds for the fluid in the above example.

Charge generation increases at higher fluid velocities and larger pipe diameters, becoming quite significant in pipes 8 inches (200 mm) or larger. Static charge generation in these systems is best controlled by limiting fluid velocity. The British standard BS PD CLC/TR 50404:2003 (formerly BS-5958-Part 2) Code of Practice for Control of Undesirable Static Electricity prescribes pipe flow velocity limits. Because water content has a large impact on the fluids dielectric constant, the recommended velocity for hydrocarbon fluids containing water should be limited to 1 meter per second.

Bonding and earthing are the usual ways charge buildup can be prevented. For fluids with electrical conductivity below 10 pS/m, bonding and earthing are not adequate for charge dissipation, and anti-static additives may be required.

The energy released in a static electricity discharge may vary over a wide range. The energy in joules can be calculated from the capacitance (C) of the object and the static potential V in volts (V) by the formula E=½ CV². One experimenter estimates the capacitance of the human body as high as 400 picofarads, and a charge of 50,000 volts, discharged e.g. during touching a charged car, creating a spark with energy of 500 millijoules. Another estimate is 100-300 pF and 20,000 volts, producing a maximum energy of 60 mJ. IED 479-2:1987 states that a discharge with energy greater than 5000 mJ is a direct serious risk to human health. IEC 60065 states that consumer products cannot discharge more than 350 mJ into a person.

The maximum potential is limited to about 35-40 kV, due to corona discharge dissipating the charge at higher potentials. Potentials below 3000 volts are not typically detectable by humans. Maximum potential commonly achieved on human body range between 1 and 10 kV, though in optimal conditions as high as 20-25 kV can be reached. Low relative humidity increases the charge buildup; walking 20 feet (6.1 m) on vinyl floor at 15% relative humidity causes buildup of voltage up to 12 kilovolts, while at 80% humidity the voltage is only 1.5 kV.

As little as 0.2 millijoules may present an ignition hazard; such low spark energy is often below the threshold of human visual and auditory perception.

Typical ignition energies are:
0.017 mJ for hydrogen
0.2-2 mJ for hydrocarbon vapors
1-50 mJ for fine flammable dust
40-1000 mJ for coarse flammable dust.

The energy needed to damage most electronic devices is between 2 and 1000 nanojoules.

A relatively small energy, often as little as 0.2-2 millijoules, is needed to ignite a flammable mixture of a fuel and air. For the common industrial hydrocarbon gases and solvents, the minimum ignition limit required for ignition of vapor-air mixture is lowest for the vapor concentration roughly in the middle between the lower explosive limit and the upper explosive limit, and rapidly increases as the concentration deviates from this optimum to either side. Aerosols of flammable liquids may be ignited well below their flash point. Generally, liquid aerosols with particle sizes below 10 micrometers behave like vapors, particle sizes above 40 micrometers behave more like flammable dusts. Typical minimum flammable concentrations of aerosols lay between 15 and 50 g/m³. Similarly, presence of foam on the surface of a flammable liquid significantly increases ignitability. Aerosol of flammable dust can be ignited as well, resulting in a dust explosion; the lower explosive limit usually lies between 50 and 1000 g/m³; finer dusts tend to be more explosive and requiring less spark energy to set off. Simultaneous presence of flammable vapors and flammable dust can significantly decrease the ignition energy; a mere 1 vol. % of propane in air can reduce the required ignition energy of dust by 100 times. Higher than normal oxygen content in atmosphere also significantly lowers the ignition energy.

There are five types of electrical discarge:
Spark, responsible for the majority of industrial fires and explosions where static electricity is involved. Sparks occur between objects at different electric potentials. Good grounding of all parts of the equipment and precautions against charge buildups on equipment and personnel are used as prevention measures.
Brush discharge occurs from a nonconductive charged surface or highly charged nonconductive liquids. The energy is limited to roughly 4 millijoules. To be hazardous, the voltage involved must be above about 20 kilovolts, the surface polarity is negative, flammable atmosphere is present at the point of discharge, and the discharge energy is sufficient for ignition. Due to maximum charge density on surface, an area of at least 100 cm² has to be involved. Not observed as a hazard for dust clouds.
Propagating brush discharge is high in energy and dangerous. Occurs when an insulating surface of up to 8 mm thick (e.g. a teflon or glass lining of a grounded metal pipe or a reactor) is subjected to a large charge buildup between the opposite surfaces, acting as a large-area capacitor.
Cone discharge, also called bulking brush discharge, occurs over surfaces of charged powders with resistivity above 10¹⁰ ohms, or also deep through the powder mass. Cone discharges aren't usually observed in dust volumes below 1 m³. The energy involved depends on the grain size of the powder and the charge magnitude, and can reach up to 20 mJ. Larger dust volumes produce higher energies.
Passive Solutions
INDUCTION
Removing or neutralizing static electricity by induction is the simplest and oldest method. Tinsel is the most common tool for this application. However, tinsel is oftentimes misused and, therefore, oftentimes not successful. The first thing that must be recognized is the fact that any induction device, such as tinsel, will never reduce or neutralize static electricity to the zero potential level. This is due to the fact that a threshold or beginning voltage is required to “start” the process.
First, the correct induction equipment must be utilized. The induction bar must be well grounded electrically. The induction bar must be stretched tight and placed ¼ of an inch from the material to be neutralized. There must be “free air space” under the material to be neutralized directly under or over the spot where you place the tinsel. In this fashion the induction will reduce static electricity on both sides of the static laden material.
Actually, if the above steps are utilized, the sharp ends or points of the grounded induction device will ionize the air over the surface being neutralized, because the grounded sharp ends are placed within the electrostatic field that is present due to static electricity. If the static charge is negative in polarity, the electrostatic field is negative and positive ions are generated via the grounded sharp ends of the induction device and the positive ions are attracted back to the static laden surface. Conversely, if the static charge is positive in polarity, negative ions will be generated by the grounding induction device and attracted back to the charged area.
Induction does work but is limited to reducing the level of static to a threshold level which usually still very high. Ionization or active static control is the best way to reduce static charge on non-conductive surfaces to very low levels.
GROUNDING
It is also possible to disturb the molecular construction of your operator. If an operator is isolated by standing on a wooden floor or wearing crepe rubber soles, he will soon pick up a voltage gradient. For example, it is possible for an operator to charge to several hundred volts each time he handles a piece of charged plastic. As he handles many different pieces, he will become charged to a higher voltage gradient until a flash-over will occur and the operator receives a shock, and or damages a static sensitive device. This can be prevented by having your operator stand on a grounded conductive mat, by the use of personnel grounding equipment that is commercially available and by ionization.
Personnel grounding equipment becomes important if your operators are sitting while working. This is the best means of isolating operators and, therefore, they become extremely vulnerable to static discharge due to charging. This phenomenon can be related to an individual dragging his feet on the living room rug and then discharging himself by touching a well-grounded lamp.
In addition, grounding of all your plant machinery and related equipment is most important. It never ceases to amaze us that so many plants are operating machinery that is not grounded electrically. Besides the safety factor, a grounded machine will help drain off extremely high charges of static electricity from partial conductors. Remember, grounding is only an aid to reducing your problems with static electricity. It is not a solution.
For example, grounding your operators will not drain off static electricity from their clothing. Also, it will not drain off static electricity from a plastic container one maybe holding. The conductivity of some clothing and most plastics is so low that electricity cannot flow to a ground; hence, “static electricity.” To solve this problem, ionization or active static control must be utilized.

### Known Active Solutions to Reduce Static

IONIZATION
By following the above steps, you can reduce the hazards of building up high charges of static electricity to a point. However the above steps are passive and of limited effectiveness. An active method static control is by ionization. It is important to understand that static electricity cannot be entirely eliminated. In fact, the terminology, “static eliminators,” is definitely misleading.
Static eliminators are really ionizing units that produce both positive and negative ions to be attracted by the unbalanced material so that neutralization does occur. For example, a charged piece of material can be neutralized by utilizing a static neutralizer. However, it does not eliminate the static electricity because, if the material is again frictioned after being neutralized, static electricity will be generated.
In order to gain the most benefit from your static neutralizing equipment, it is important that you understand how they operate and how they provide the means of neutralization. Most electronic static neutralizers are constructed by placing a high voltage on a sharp point in close proximity to a grounded shield or casing. There are two basic types static control ionizers—AC & DC.
With Alternating Current ionizers the high voltage alternates current pulses through the 60 cycle operation, the air between the sharp points and the grounded casing is actually broken down by ionization and therefore both positive and negative ions are being generated. Half of the cycle is utilized to generate negative ions and the other half is utilized to generate positive ions. On 50 or 60 cycles per second power grid polarity is changing ionization every 1/100 or 1/120 of a second.
DC ionizers also put a high voltage on a sharp point but need to produce the opposite polarity by a second power supply or some kind of circuitry to switch polarity.
Both AC and DC Systems have advantages. The application, cost, performance, space are all factored into deciding the proper type of ionizer to use.
If the material being neutralized is charged positive, it will immediately absorb negative ions from the static neutralizer and repel the positive ions. When the material becomes neutralized, there is no longer electrostatic attraction and the material will cease to absorb ions. Conversely, if the material being neutralized is charged negative, it will absorb the positive ions being generated by the neutralizer and repel the negative ions. Again, once neutralization is accomplished, the material will no longer attract ions. See figure below.
Nuclear-powered equipment may also be used to generate ionized air for static neutralization. These devices, powered by Polonium 210 isotopes which have a half-life of only 138 days, are continually losing their strength and must be replaced annually. They are more expensive and less effective than electrically powered devices. These nuclear devices cannot be purchased and are leased by users. One year lease costs are usually more than the purchase price of comparable electrically powered devices.
SOLUTION
In order to solve problems related to static electricity, certain basic steps must be taken. The logical approach should be:
A. Identify the problem using a static meter.
B. Define the problem and goals needs to be reached to consider the problem solved.
C. Determine the solution options with the help of experienced engineers
D. Select the proper equipment to solve the problem.
Trouble shooting a static electricity problem, some sort of measuring equipment is helpful to measure the amount of static electricity that is present and identify the polarity as either positive or negative. Measuring and locating static electricity will remove the mystery often associated with this phenomenon.
Once the problem is identified and goals defined, the solution options should be considered next with the help of experienced engineers. Can the static electricity be controlled by grounding, induction, ionization or a combination thereof?
In making this decision, keep in mind the facts mentioned, relative to conductivity. With pure conductors or partial conductors (such as the human body), grounding should be considered. However, if you are working with insulators, such as plastics, ionization must be added.

### SUMMARY OF THE INVENTION

The present invention includes a static electricity removal system for removing aerial borne static comprising: a conductive shell, a removal system support system, a conductive internal element supported by the removal system support, the conductive internal element being free of conductive contact with the shell, one end of the conductive internal element being directed towards an exit port from the shell, the one end of the conductive internal element in electrical connection with an insulated electrical drain element, and the insulated electrical element being grounded.

### BRIEF DESCRIPTION OF THE FIGURES

FIG. 1 shows a perspective view of a static electricity draining system.

FIG. 2 shows a side view of another embodiment of an electricity draining system within the generic concept of the invention.

### DETAILED DESCRIPTION OF THE INVENTION

The present invention includes a static electricity removal system for removing aerial borne static comprising: a conductive shell, a removal system support system, a conductive internal element supported by the removal system support, the conductive internal element being free of conductive contact with the shell, one end of the conductive internal element being directed towards an exit port from the shell, the one end of the conductive internal element in electrical connection with an insulated electrical drain element, and the insulated electrical element being grounded.

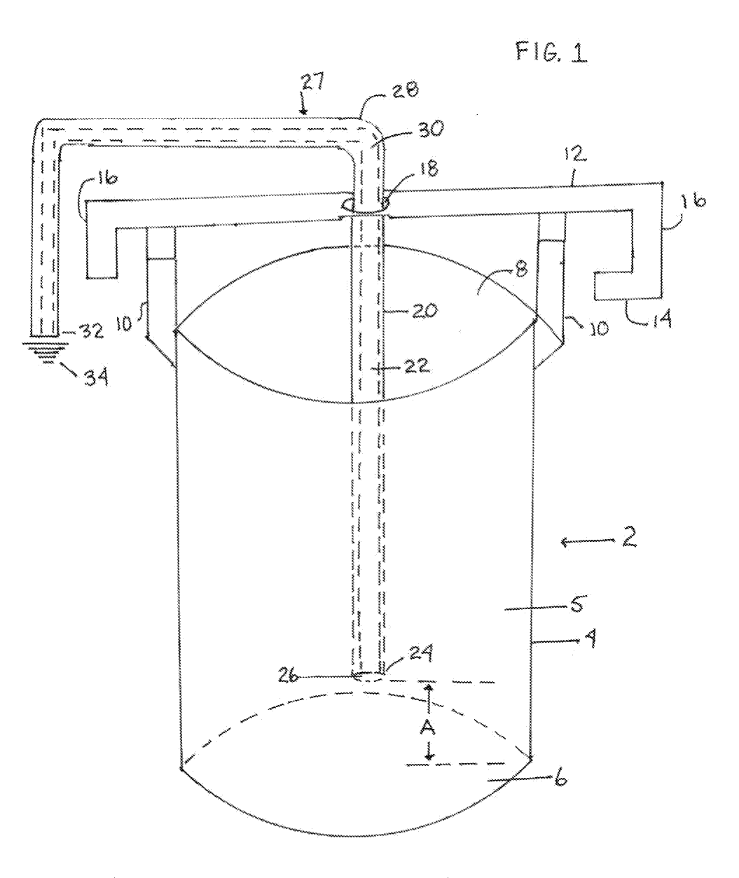

FIG. 1 shows a single embodiment of the self-contained static electricity drain system 2 which is a generic invention according to the description provided herein. Applicant does not attempt to explain any theories by which the present technology has been found to work, but asserts that the technology is believed to function with the generic structures defined.

FIG. 1 shows a single embodiment of the self-contained static electricity drain system 2 that is representative of the generic invention described herein. The components described and shown in the figure are individual species that are representative of generic components. The shape, size and composition of each component in the Figure are not to be seen as limiting the scope of the invention but are merely examples within the generic scope of the disclosed invention. The system 2 shown has a containment shell 4 and an optional base 6. The shell 4 is porous or open, allowing flow of ions in the environment (e.g., as carried by air) from the environment outside the shell 4 accessing the volume 5 within the shell 4. The shell 4 is shown as cylindrical and symmetrical, but the shape is not material to the invention as long as the functional parameters described are met in any other embodiment. The shell 4 may be constructed of any solid material and is preferably a conductive material such as metal or metal-coated elements such as a mesh, cross-hatch pattern, sheet material with holes punched therein, or any other containment structure that can function as the shell 4. The size of the system can be varied greatly to accommodate the size of the volume in which the system 2 is being used to reduce static electricity in the air. For smaller closed environments (e.g., storage closets, equipment rooms, etc.) the size of the device may be as small as 25 cm in height and 6 cm in diameter (or width). Multiple units may be used for larger closed or open volumes or a larger system may be used.

For example, a metal frame shopping cart can be converted to a static drain system 2 according to the present invention. Systems of dimensions up to meters in height and width are easily contemplated within the scope of the present invention. In a preferred embodiment, the shell is a self-supporting mesh cage, such as made with steel, stainless steel, aluminum or copper. An insulating coating or protective coating (anti-rust) may or may not be on the surface of the shell 4.

Shown in FIG. 1 is a bar support system 12 that supports the static electricity system 2. In this embodiment, a support bar 12 is shown with a first support arm 14 and an optional support arm 16 on an opposite side of the support bar from the first arm 14. These arms 14, 16 may be attached to walls, shelves, poles, ledges, or any other structure. The bar 12 and arms 14, 16 are preferably electrically insulated from the shell 4 as by rigid, elastomeric or rubbery electrically insulating flexible connectors 10, which may be elastic straps, bands, ceramic, polymeric or other insulating element between the support bar 12 and the shell 4. The connector may flex, rotate, gimbal, or telescope in its connection or be a rigid connection. The top level 8 of the shell 4 may be open or closed, porous or non-porous, conductive or insulating. The support bar 12 may have a hole 18 therein or any other internal element 20 support system such as snaps, grooves, guides, or the like. In the Figure, the internal element shown is a flexible conductive, non-insulated metal chain 20 that extends towards the base 6 of the shell 4 without establishing a conductive connection between the internal element 20 and the base 6. If the base 6 is conductive, any conductive end 24 of the internal conductive element 20 should be separated from the base 6 by a space A and/or have an insulating cap 26 on the internal element 20. If the base 6 is electrically insulating, the bottom 24 of the internal element 20 may contact the base 6, but should not be fixed thereto, but the bottom 24 should be able to slide across the base 6 as the static electricity drain system 2 shifts its orientation. The believed purpose of the internal element 20 I to sweep or attract static electrical charge in the area where the drain system 2 is placed Charge that is engaged by the internal element 20 is carried by an insulated drain lead 27 having a conductive interior 30 and an insulating cover 28. The conductive internal element 30 may be a wire, cable, conductive particle loaded carrier (e.g., polymer) and may be metallic or carbon fiber material, by way of non-limiting examples. The insulated drain lead 27 extends to an end 32 that must be grounded and preferably even physically embedded into the ground or connected to a grounded pole acting as a ground extension.

The internal element 20 may be a single element or multiple elements or the same or similar elements evenly or asymmetrically distributed within the shell. Each internal element 20 may have its own drain lead that is individually grounded, or individual drain leads (and grounding) may have one or more internal elements connected to them by parallel connections so that at least some drain leads may ground multiple internal elements 20. An example of a portable static electric drain system can be constructed from a typical metal shopping cart. Multiple support arms can support and distribute single or multiple internal elements and assist in connecting them to individual or collective individual drain leads. The wheels of the cart, usually being rubber or elastomeric, insulates the shell (the carrying area) of the shopping cart from the ground. The functional requirements or options for a single shell/internal element/drain lead and ground would still apply to each of the carried internal elements would still be practiced.

It has been estimated that current of between 0.01 to 0.15 amps DC may be generated between the shell and the ground connection.

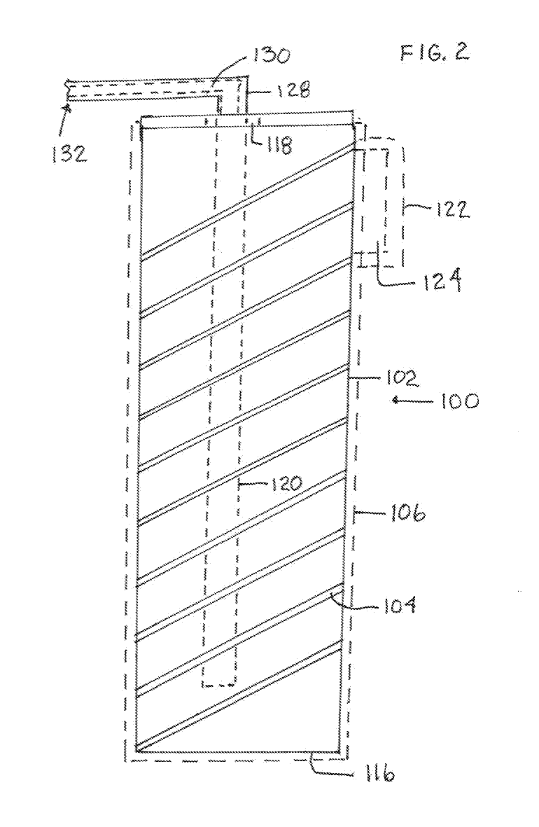

FIG. 2 shows a side view of another embodiment of an electricity draining system 100 within the generic concept of the invention. The system 100 is similar to that of FIG. 1, with an optional wound inductive wire system 104 wound about the shell 102. There is also a further optional insulating covering 106 over the inductive wiring system 104. The system 100 has a base 116 and an optional handle 122 with an opening 124 for securing the system 100 to a support (not shown). The flexible internal conductive element 120 is shown within the shell 102. The flexible internal conductive element 120 is shown extending out of the shell 102 through hole 118 as the internal conductive wire/cable 130 with an insulating covering 128. FIG. 2 shows the truncated flexible internal conductive element 120 is shown truncated at end 132 where it would extend to a ground (not shown) as in FIG. 1. A static electricity removal system for removing aerial borne static may have:

a conductive shell, a removal system support system, a conductive internal element supported by the removal system support, the conductive internal element being free of conductive contact with the shell, one end of the conductive internal element being directed towards an exit port from the shell, the one end of the conductive internal element in electrical connection with an insulated electrical drain element, and the insulated electrical element being grounded.

The removal system optionally has an inductive coils is wrapped about the outside of the shell. The removal system may have an insulating material is between the inductive coils and the shell or above the inductive coils and the shell.

The system is also believed to have capability in withdrawing positive airborne radionuclide ions from the air. The invention may have directional sensitivity and may be associated with support surfaces such as sheetrock, polymeric surfaces, ceramic surfaces and other non-conductive surfaces. The system, referred to herein as “Simontricity” after the inventor, has an undetermined volumetric effect. Volumes of more than 10 cubic feet and much more can benefit from the drainage system of the present technology.

Although specific materials and dimensions are recited and described, they are not intended to limit the scope of the invention except where specifically recited in the claims. Variations will be appreciated by those skilled in the art.

1. A static electricity removal system for removing aerial borne static comprising:
a conductive shell, a removal system support system, a conductive internal element supported by the removal system support, the conductive internal element being free of conductive contact with the shell, one end of the conductive internal element being directed towards an exit port from the shell, the one end of the conductive internal element in electrical connection with an insulated electrical drain element, and the insulated electrical element being grounded.

2. The removal system of claim 1 wherein the shell comprises a porous metallic frame.

3. The removal system of claim 2 wherein the porous metallic frame comprises conductive material in a structure selected from the group consisting of mesh, basket or cage.

4. The removal system of claim 3 wherein the insulated electrical drain element comprises filaments or cables of conductive material covered by an insulating layer.

5. The removal system of claim 2 wherein the conductive internal element comprises a flexible conductive internal element.

6. The removal system of claim 5 wherein the conductive internal element comprises a chain or flexible cable.

7. The removal system of claim 6 wherein the porous metallic frame comprises conductive material in a structure selected from the group consisting of mesh, basket or cage.

8. The removal system of claim 7 wherein the insulated electrical drain element comprises filaments or cables of conductive material covered by an insulating layer.

9. The removal system of claim 1 wherein an inductive coils is wrapped about the outside of the shell.

10. The removal system of claim 9 wherein an insulating material is between the inductive coils and the shell.

11. The removal system of claim 9 wherein an insulating material is above the inductive coils and the shell.

12. A method of removing static from an environment comprising placing the device of claim 1 into an environment where static electricity is present and attaching the electrical element to a ground.

13. The method of claim 12 wherein the ground is actual ground on the earth.
